(19) United States
(12) Patent Application Publication
(10) Pub. No.: US 2020/0122206 A1
(43) Pub. Date: Apr. 23, 2020

(54) Method And System For Moving Substances And Preventing Corrosion In A Conduit

(71) Applicant: Ellina Beliaeva, Mexico City (MX)

(72) Inventor: Ellina Beliaeva, Mexico City (MX)

(21) Appl. No.: 16/605,496

(22) PCT Filed: Mar. 29, 2018
(86) PCT No.: PCT/IB2018/052159

§ 371 Date: Oct. 15, 2019

Related U.S. Application Data
(60) Provisional application No. 62/485,933, filed on Apr. 15, 2017.

(51) Int. Cl. B08B 9/032

(52) U.S. Cl. CPC B08B 9/0325

(57) ABSTRACT

A conduit or pipeline system configured to use a liquid containing fluid, such as water, which typically accumulates in low flow pipelines causing corrosion and accumulation of sediments, to remove sediments and prevent corrosion. The liquid-containing fluid can be introduced into gas lines to remove solids, for example, black powder.

### CROSS-REFERENCES TO RELATED APPLICATIONS

This application claims priority from U.S. Provisional Application Ser. No. 62/485,933 filed Apr. 15, 2017, which is hereby incorporated herein by reference in its entirety.

### TECHNICAL FIELD

The present invention generally relates to methods and systems for transporting solids and/or fluids though a conduit and/or for preventing corrosion of the conduit. More particularly, the present invention relates to a method and a system for transporting solids and/or fluids though a conduit and/or for preventing internal and/or external corrosion of the conduit using one or more volumes of a liquid-containing fluid moving along the conduit.

### BACKGROUND OF THE INVENTION

Numerous studies (for example, Smart, J. S., and Pickthall, T., “Internal Corrosion Measurement Enhances Pipeline Integrity”, Pipeline & Gas Journal, October 2004) indicate that bacteria are one of the most common causes of corrosion of pipelines transporting hydrocarbon fluids (oil, condensate, and/or gas). The rate of microbially induced corrosion varies “from a few mils per year in chemically treated or cold systems, to over 200 mpy in systems with good growth conditions” according to the study cited above. Water temperature is a very important factor that affects the corrosion rate because the bacteria die at temperatures above 140° F. and stop growing below 50° F.

A stationary or near stationary bed (layer) of solids or sludge formed in the bottom of the pipelines and the presence of the bacteria, especially sulfate-reducing bacteria in the sediments, contribute significantly to under deposit corrosion since it creates the good conditions for the bacteria growth. Non-limiting examples of the solids include proppant, formation solids, formation sand, black powder, or scale. Non-limiting examples of the sludge include the acid sludge produced as a result of the injection of an acid stimulation fluid into a reservoir, drilling mud, or the sludge formed due to the precipitation of the heavier fractions of hydrocarbons in oil pipelines, in particular, in those into which a demulsifier in injected. In many applications, the flow rate of the transported fluid(s) is not sufficiently high to remove solids or sludge from the pipeline and cannot be increased (e.g., in a flowline connected to an oil or gas well having a limited production rate).

Problem 2. The injection of oilfield chemicals (e.g. a corrosion inhibitor, a scale inhibitor, and the like) into the stream of transported fluids in pipelines operated at low flow rates may be inefficient since the chemical cannot be evenly distributed over the internal surface of the pipeline.

Problem 3. The bed of solids or sludge or accumulations of water may reduce the temperature of the outer wall of the pipeline and increase the moisture content of the surrounding medium (soil or sand), thereby causing the internal corrosion of the pipeline.

A common practice currently used in the industry is based on the use of devices known in the art as pipeline pigs. On such pig is described in U.S. Pat. No. 3,643,280 A. The pig includes any device, such as piston or sphere made of solid material or foam or gel, compatible with the pipeline. The pig is propelled through the pipeline under the pressure exerted by a suitable fluid behind the pig. However, in many applications, the pig cannot be used (unpiggable pipelines) since the pipeline is not designed to perform pigging operations (e.g., the pipeline does not include a pig launcher and a pig receiver, or the pipeline may have bends, interconnections with other pipelines, valves, etc). This technique does not prevent external corrosion.

Application US Patent Application Publication No. 20100147332 describes a method of cleaning sediment from a liquid-transporting pipeline by means of injecting gas into the pipeline. The injected gas forms a bubble in the pipeline and the bubble travels in a direction towards a discharge of the pipeline. Disadvantages: 1) this technique requires a separate source of gas and a system for injecting gas; 2) gas injection in pipelines carrying liquids may produce a high pressure drop caused by gas accumulation in the downward inclined sections of the pipeline; 3) is not applicable to gas pipelines having accumulations of solids or sludge. This technique does not prevent external corrosion.

And nonmetallic pipes or internal and/or external coatings have been used to overcome the above problems, however these techniques have many technical (limited diameter and pressure) and economical limitations (some non-metallic pipes can be more expensive than steel pipes).

### BRIEF SUMMARY OF EMBODIMENTS OF THE INVENTION

According to one embodiment of the invention, a conduit system for transporting solids and/or fluids, comprises a first pipe-shaped or vessel-shaped body, which comprises: a first-body lower part; a first-body upper part disposed above the first-body lower part; a first-body inlet end; a first-body outlet end; a first-body main inlet; a first-body upper outlet; and a first-body lower outlet. The conduit systems has a second conduit in fluid communication with the first-body lower outlet and a third conduit. The third conduit comprises: a third-conduit inlet end; a third-conduit outlet end in fluid communication with the first pipe-shaped or vessel-shaped body; and a third-conduit opening in fluid communication with the second conduit. The conduit system comprises a first valve disposed in the third conduit between third-conduit inlet end and the third-conduit opening. The first-body upper outlet is connected to the third-conduit inlet end or to the first valve.

In a variant, a first port disposed in the third conduit or in the first-body upper part. A second port is disposed in the second conduit or in the first-body lower part. The conduit system has a first device for measuring a first pressure difference between the first port and the second port to determine a volume of the liquid-containing fluid or of the light fluid in first-body lower part and/or in second conduit.

In another variant, the system has a second device for measuring temperature and/or moisture content at a desired location in the first pipe-shaped or vessel-shaped body.

In a further variant, the system has a heating device disposed upstream of third-conduit opening, for heating up the liquid-containing fluid and/or the light fluid.

In still another variant, the system has a controller, having a processor and a memory, configured to regulate the amount of heat supplied to the liquid-containing fluid and/or to the light fluid in the heating device. The controller is in communication with the heating device and has, stored on the memory, a known or determinable critical moisture content or a known or determinable first sterilization temperature or a known or determinable second sterilization temperature or any combination thereof.

In yet a further variant, the controller is configured to regulate a flow rate of an added substance introduced into the first pipe-shaped or vessel-shaped body or into any other element of the system from a source. The controller comprises a timer for measuring a time interval and is configured to store a set-point time, a first specified pressure difference, and a second specified pressure difference greater than the first specified pressure difference.

In a variant, the system has a second valve for changing a flow rate of fluids through the first-body lower outlet, disposed in the second conduit.

In another variant, the system has a first-body inlet pipe connected to the first-body main inlet. The first pipe-shaped or vessel-shaped body, the second conduit, the third conduit, and the first-body inlet pipe have circular cross-sections. A cross-sectional area of the first pipe-shaped or vessel-shaped body is greater than the cross-sectional area of the first pipe-shaped or vessel-shaped body.

In still another variant, a plurality of the conduit systems comprises a controller controlling the first valves and a common conduit having an a common-conduit outlet end. The first-body outlet ends of each first pipe-shaped or vessel-shaped body communicates fluidly with the common conduit. The controller is configured to open and close the first valve such that a volume of liquid-containing fluid enters the common conduit substantially simultaneously with volumes of liquid-containing fluid from at least another of the plurality of systems to form a volume of liquid-containing fluid moving toward the common-conduit outlet end.

In yet a further variant, an internal volume of the first pipe shaped or vessel-shaped body is greater than an internal volume of second conduit.

In a variant, a source is in fluid communication with an injection pipe inserted into or connected to the to inject or introduce an added substance into the first body lower part.

In another variant, the first pipe-shaped or vessel-shaped body is vertically oriented, such that first-body inlet end is disposed in the first-body upper part, and the first-body outlet end is disposed in the first body lower part, and the first-body upper outlet is disposed adjacent to or at first-body inlet end.

In a further variant, the system has a second valve and a second conduit, for separating the liquid containing fluid from the light fluid, accumulating, and substantially discharging the fluids into the first pipe-shaped or vessel-shaped body a known or determinable amount of compressible fluid required to provide a desired velocity of volume of liquid-containing fluid over a desirable time interval.

In still another variant, the second conduit comprises: a second-body lower part; a second-body inlet end; a second-body inlet disposed close to or at second-body inlet end in the second-body lower part; a second body upper part; a second-body outlet end; and a second-body outlet disposed close to or at second-body outlet end in the second-body lower part. The first-body main inlet is connected to the second-body outlet by a first-body inlet pipe.

In yet a further variant, the second conduit further comprises a second-body inlet pipe connected to the second-body inlet.

In a variant, the system has a second valve. The first-body upper outlet end is disposed between first-body lower part and first-body upper part and the first-body main inlet is disposed between the first body lower part and the first-body upper part. The system is configured to accumulate a known or determinable amount of compressible fluid in the first-body upper part and then expanded into the first-body lower part.

In another variant, the first pipe-shaped or vessel-shaped body is vertically oriented, such that the first-body inlet end is disposed in the first body upper part, and the first-body outlet end is disposed in first-body lower part, and the first body upper outlet is disposed between first-body lower part and first-body upper part.

In a further variant, a method of fluid transport in a pipe system, comprises: providing a flow of liquid-containing fluid and light fluid into a first pipe-shaped or vessel-shaped body; substantially separating the liquid-containing fluid from the light fluid in the first pipe-shaped or vessel-shaped body and accumulating a first volume of liquid-containing fluid in a first-body lower part and/or a second conduit; substantially separating the liquid-containing fluid from the light fluid in the first pipe-shaped or vessel-shaped body and accumulating a second volume of light fluid; and substantially discharging the first volume of liquid-containing fluid through a third-conduit opening and a third-conduit outlet end into a first conduit.

In still another variant, a method of fluid transport in a pipe system, having an inner wall and an outer wall, comprises: providing a flow of one or more transported substances into a first pipe-shaped or vessel-shaped body to allow a first volume of liquid-containing fluid to travel along a first conduit in a direction, such that a static or slowly moving substance is accelerated in the direction; transferring heat from the first volume of liquid-containing fluid to the inner wall to increase its temperature, if a temperature of the fluid is greater than the temperature of the inner wall; transferring heat from the first volume of liquid-containing fluid to the outer wall through the inner wall to increase a temperature of the outer wall; transferring heat from the first volume of liquid-containing fluid through the inner wall to a water-containing solid medium to decrease its moisture content.

In yet a further variant of the method, a substance is added to the liquid-containing fluid or in light fluid or to the one or more transported substances.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a schematic drawing of a first embodiment of a system for moving a static or slowly moving substance and/or for preventing corrosion in the first conduit.

FIG. 1A is an enlarged view of the portion circled in FIG. 1 and marked 1A showing a first pipe shaped or vessel-shaped body, a second conduit, a third conduit, a first valve, and a second valve (optional).

FIG. 2A is an enlarged view of the portion circled in FIG. 1 and marked 1A, when a volume of liquid-containing fluid is accumulated in a first-body lower part and the second conduit.

FIG. 2B is an enlarged view of the portion circled in FIG. 1 and marked 1A, when a volume of light fluid is accumulated in the first-body lower part and the second conduit.

FIG. 2C is a schematic drawing of the first conduit of FIG. 1 in which the volume of liquid containing fluid travels along the first conduit toward a first-conduit outlet end.

FIG. 2D is a schematic drawing of the first conduit of FIG. 1 in which the volume of liquid containing fluid and the volume of light fluid travel along the first conduit toward the first-conduit outlet end.

FIG. 3A is an isometric view of the first pipe-shaped or vessel-shaped body of an additional embodiment.

FIG. 3B is an isometric view of the first pipe-shaped or vessel-shaped body comprising a first-body inserted pipe having a plurality of openings.

FIG. 4 is a schematic drawing of the first pipe-shaped or vessel-shaped body having the internal volume greater than the internal volume of the second conduit.

FIG. 5 is an isometric view of the first pipe-shaped or vessel-shaped body comprising an injection pipe inserted into the pipe-shaped or vessel-shaped body for injecting an added substance from a third source (not shown in FIG. 5).

FIG. 6 is an isometric view of the first pipe-shaped or vessel-shaped body being vertically oriented.

FIG. 7A is a schematic drawing of another additional embodiment comprising a second pipe-shaped or vessel-shaped body and a second valve, when the volume of liquid-containing fluid is accumulated in the first-body lower part and the second conduit.

FIG. 7B is a schematic drawing of the embodiment of FIG. 7A, when the volume of the light fluid is accumulated in the first-body lower part and the second conduit.

FIG. 7C is an isometric view of the second pipe-shaped or vessel-shaped body.

FIG. 8A is a schematic drawing of another additional embodiment comprising the first pipe-shaped or vessel-shaped body having a first-body upper outlet disposed between the first-body lower part and a first-body upper part, when the volume of liquid-containing fluid is accumulated in the first body lower part and the second conduit.

FIG. 8B is a schematic drawing of the embodiment of FIG. 8A, when the volume of the light fluid is accumulated in the first-body lower part and the second conduit.

FIG. 9 is an isometric view of the first pipe-shaped or vessel-shaped body being vertically oriented and having the first-body upper outlet disposed between the first-body lower part and the first-body upper part. The figures are not intended to be exhaustive or to limit the invention to the precise form disclosed. It should be understood that the invention can be practiced with modification and alteration, and that the invention be limited only by the claims and the equivalents thereof.

FIG. 10 is a schematic drawing of yet another embodiment comprising a plurality of systems of FIG. 1, a second controller controlling the first valves, and a common conduit.

### DETAILED DESCRIPTION OF THE EMBODIMENTS OF THE INVENTION

### The following reference numerals are used in this document:

17 third conduit
18 first conduit
19 first-body inlet pipe
20 first-conduit inlet end
21 second-body inlet pipe
22 first-conduit outlet end
23 third source
24 first source
27 static or slowly moving substance
28 light fluid
29 third-conduit inlet end
30 one or more transported substances
31 first-body inlet end
33 first-body outlet end
34 first valve
35 second valve
36 first pipe-shaped or vessel-shaped body
37 second pipe-shaped or vessel-shaped body
38 second conduit
40 volume of liquid-containing fluid
42 volume of light fluid
44 direction of movement of one or more transported substances
46 first-body lower part
48 first-body upper part
50 first-body main inlet
51 second-body inlet end
52 first-body upper outlet
53 second-body outlet end
54 water-containing solid medium
55 inner wall
56 third-conduit opening
57 outer wall
58 first-body lower outlet
60 first device
61 second-body inlet
62 second device
63 second-body outlet
64 one or a plurality of devices
69 one or more controllers
70 first-body inserted pipe
72second-body lower part
74 second-body upper part
80 first port
82 second port
84 third port
86 fourth port
88 second source
90 third-conduit outlet end
91 common conduit
92 a second controller
93 common-conduit outlet end
94 volume of liquid-containing fluid formed from a plurality of systems

In the description which follows, like elements are marked throughout the specification and drawing with the same reference numerals, respectively. The drawings are not necessarily to scale and certain features may be shown in somewhat schematic or generalized form in the interest of clarity and conciseness.

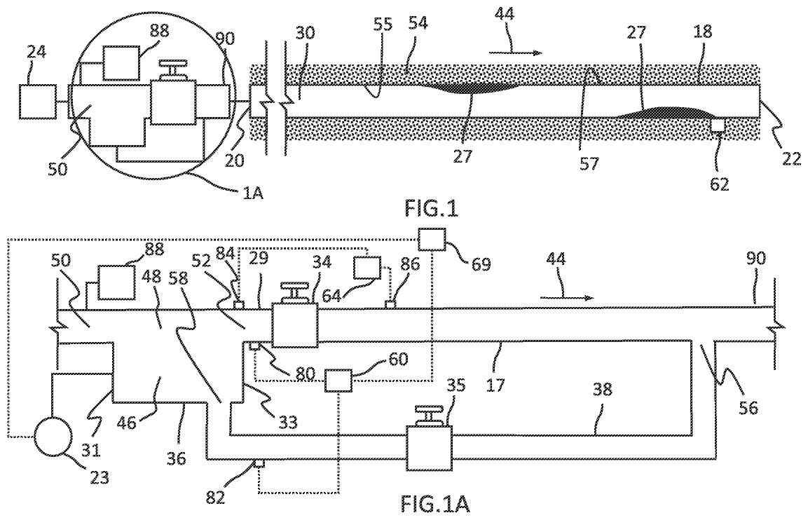

Turning to the drawings, there is shown in FIG. 1 a schematic diagram of a first embodiment of a system to move a static or slowly moving substance generally indicated 27 and/or to prevent corrosion in a first conduit 18 for conveying one or more transported substances 30 flowing from a first source 24. First conduit 18 has a first-conduit inlet end generally indicated 20, a first-conduit outlet end generally indicated 22, an inner wall generally indicated 55, and an outer wall generally indicated 57. In the following description, the terms “upstream” and “downstream” are used with reference to a direction 44 of movement of one or more transported substances 30 along first conduit 18 from first-conduit inlet end 20 to first-conduit outlet end 22.

Non-limiting examples of first source 24 include a well producing from a subterranean reservoir, another conduit (e.g., a pipeline or a manifold) conveying one or more transported substances 30 and being located upstream of first conduit 18, a vessel, and the like. Non-limiting examples of first conduit 18 include a crude oil pipeline, a gas pipeline, a flowline (a pipeline carrying fluids produced from a well), a petroleum-product pipeline, a water pipeline, a sewage pipeline, a slurry pipeline, a liquid sulfur pipeline, a beer pipeline, a manifold in a pipeline system, a pipe of a process plant piping system, and the like. One or more transported substances 30 comprise a liquid-containing fluid (not shown in FIG. 1) and a light fluid (not shown in FIG. 1), or the liquid-containing fluid, or the light fluid. The liquid-containing fluid has a first density and comprises one or more fluids including at least one liquid.

The light fluid has a second density smaller than the first density. Non-limiting examples of the liquid-containing fluid include a hydrocarbon liquid, water, an emulsion of oil and water, a suspension, a gel, a liquid with dispersed bubbles of a gas, and the like. Non-limiting examples of the light fluid include a gas, the hydrocarbon liquid, being conveyed alone or with the liquid-containing fluid comprising water, a foam, a liquid aerosol, and the like. If one or more transported substances 30 at first source 24 do not comprise or are substantially free of either the liquid-containing fluid or the light fluid, then a second source 88 of an injected fluid (not shown in FIG. 1) is provided. If one or more transported substances 30 at first source 24 do not comprise or are substantially free of the liquid-containing fluid, then the injected fluid comprises the liquid containing fluid. If one or more transported substances 30 at first source 24 do not comprise or are substantially free of the light fluid, then the injected fluid comprises the light fluid. Non-limiting examples of second source 88 include a pipeline, a vessel, a well producing from a subterranean reservoir, and the like. Also, static or slowly moving substance 27 optionally may be inside first conduit 18. Non-limiting examples of static or slowly moving substance 27 include solids produced from a well, such as, for example, proppant or formation solids; sediments; a paraffin wax; a completion fluid; sludge; unwanted pipeline debris; a stagnant or slowly flowing fluid, and the like. One or more transported substances 30 optionally may comprise static or slowly moving substance 27 and/or an added substance (not shown). Non-limiting examples of the added substance include a biocide, a drag reducing agent, a demulsifier, a chemical inhibitor, such as a corrosion inhibitor, a gas hydrate inhibitor, a scale inhibitor, and the like.

Outer wall 57 optionally may be in contact with a water-containing solid medium 54 having a third temperature and a moisture content. The moisture content causes corrosion of outer wall 57 when the moisture content is greater than a known or determinable critical moisture content. Inner wall 55 optionally may have a first temperature and be exposed to first microorganisms causing corrosion when the first temperature is smaller than a known or determinable first sterilization temperature. Outer wall 57 optionally may have a second temperature and be exposed to second microorganisms causing corrosion of outer wall 57 when the second temperature is smaller than a known or determinable second sterilization temperature.

Fig. lA is an enlarged view of the portion circled in FIG. 1 and marked lA showing a pipe-shaped or vessel-shaped body 36, a second conduit 38, a third conduit 17, and a first valve 34. The function of first pipe-shaped or vessel-shaped body 36 comprises substantially separating the liquid-containing fluid (not shown in FIG. 1A) and the light fluid (not shown in FIG. 1A) from one another. Also, functions of either or both of first pipe-shaped or vessel-shaped body 36 and second conduit 38 comprise accumulating a volume (not shown in FIG. 1A) of the liquid-containing fluid, desired by the operator, or a volume (not shown in FIG. 1A) of the light fluid. First pipe-shaped or vessel-shaped body 36 has a first-body lower part generally indicated 46, a first-body upper part generally indicated 48, a first-body inlet end generally indicated 31, a first-body outlet end generally indicated 33, a first-body main inlet generally indicated 50, a first-body upper outlet generally indicated 52, and a first-body lower outlet generally indicated 58. First body lower part 46 is located below first-body upper part 48. First pipe-shaped or vessel-shaped body 36 may also have a first body auxiliary inlet (not shown). Third conduit 17 has a third-conduit inlet end generally indicated 29, a third-conduit outlet end generally indicated 90, and a third-conduit opening generally indicated 56. Second conduit 38 communicates fluidly with first-body lower outlet 58 and with third-conduit opening 56. First-body upper outlet 52 is connected to third-conduit inlet end 29 (FIG. 1A) or to first valve 34. First valve 34 is disposed in third conduit 17 between third-conduit inlet end 29 and third-conduit opening 56. Alternately, first valve 34 is disposed between first-body upper outlet 52 and third-conduit inlet end 29.

First-body main inlet 50 is disposed close to or at first-body inlet end 31, preferably in first body upper part 48. First-body upper outlet 52 is disposed close to or at first-body outlet end 33 in first-body upper part 48. First-body lower outlet 58 is disposed in the first-body lower part 46, preferably close to or at first-body outlet end 33. The sum of the internal volume of first pipe shaped or vessel-shaped body 36 and the internal volume of second conduit 38 preferably is greater than a cross-sectional area (in square meters) of first-conduit 18 multiplied by forty and divided by an internal perimeter, “wetted perimeter”, (in meters) of first conduit 18.

First-body main inlet 50 is connected to first source 24 (FIG. 1) and third-conduit outlet end 90 is connected to first-conduit inlet end 20.

Second source 88 (FIG. 1) is fluidly connected to first pipe-shaped or vessel-shaped body 36, for example, through the first-body auxiliary inlet (not shown) and/or to first source 24.

Furthermore, the first embodiment (FIG. 1A) may comprise a first device 60 (e.g., a differential manometer) for measuring a first pressure difference between a first port 80 and a second port 82 to determine a volume (not shown in FIG. 1A) of the liquid-containing fluid or of the light fluid in first-body lower part 46 and/or in second conduit 38. First port 80 is disposed in third conduit 17, as shown in FIG. 1A, or in first-body upper part 48. Second port 82 is disposed in second conduit 38, as shown in FIG. 1A, or in first-body lower part 46. The volume of the liquid-containing fluid or of the light fluid in first-body lower part 46 and second conduit 38 can be determined by those skilled in the art based on an elevation of first port 80 with respect to second port 82, design specifications of pipe-shaped or vessel-shaped body 36 and of second conduit 38, and the first density or the second density, respectively.

Additionally, the first embodiment of FIG. 1 may comprise a second device 62 (e.g., a temperature sensor and/or a soil moisture sensor) for measuring the first temperature, or the second temperature, or the third temperature, or the moisture content, or any combination thereof at a desired location in or near first conduit 18.

Also, the first embodiment of FIG. 1 may comprise a heating device (not shown) for heating up the liquid-containing fluid and/or the light fluid to a sufficiently high temperature to provide the first temperature greater than the known or determinable first sterilization temperature, or the second temperature greater than the known or determinable second sterilization temperature, or the moisture content smaller than known or determinable critical moisture content. The heating device transfers heat to at least the liquid-containing fluid and/or the light fluid in a suitable element disposed upstream of third-conduit opening 56.

Furthermore, the first embodiment may comprise one or more controllers 69 (FIG. 1A) for regulating the amount of heat supplied to the liquid-containing fluid and/or to the light fluid in the heating device (not shown). One or more controllers 69 is in communication the heating device (not shown) and second device 62 of FIG. 1. One or more controllers 69 comprises a microprocessor (not shown), and a memory (not shown) for storing the known or determinable critical moisture content or the known or determinable first sterilization temperature or and the known or determinable second sterilization temperature or any combination thereof.

Furthermore, one or more controllers 69 of FIG. 1A may alternately or additionally regulate a flow rate of the added substance introduced into first pipe-shaped or vessel-shaped body 36 or into any other element of the system from a third source 23. One or more controllers 69 alternately or additionally is in communication with third source 23 and first device 60. Third source 23 communicates fluidly with any element conveying the one or more transported substances within, or upstream of, the system. One or more controllers 69 may comprise comprises a timer device (not shown) for measuring a time interval, and a memory (not shown) for storing a set-point time, a first specified pressure difference, and a second specified pressure difference greater than the first specified pressure difference.

Also, the first embodiment of FIG. 1 may comprise a second valve 35 for changing a flow rate of one or more fluids through first-body lower outlet 58 and the light fluid mandatorily including a compressible fluid (not shown). Second valve 35 may be disposed, for example, in second conduit 38.

Furthermore, if the light fluid (not shown in FIG. 1A) comprises the compressible fluid (not shown) and second valve 35 is provided, the first embodiment may comprise one or a plurality of devices 64 (e.g., a differential manometer or two manometers) for measuring a second pressure difference between a third port 84 and a fourth port 86. Third port 84 is disposed in second pipe shaped or vessel-shaped body 36 or in any other element within the system located upstream of first valve 34 or second valve 35. Fourth port 86 is disposed in any element located downstream of first valve 34 or second valve 35.

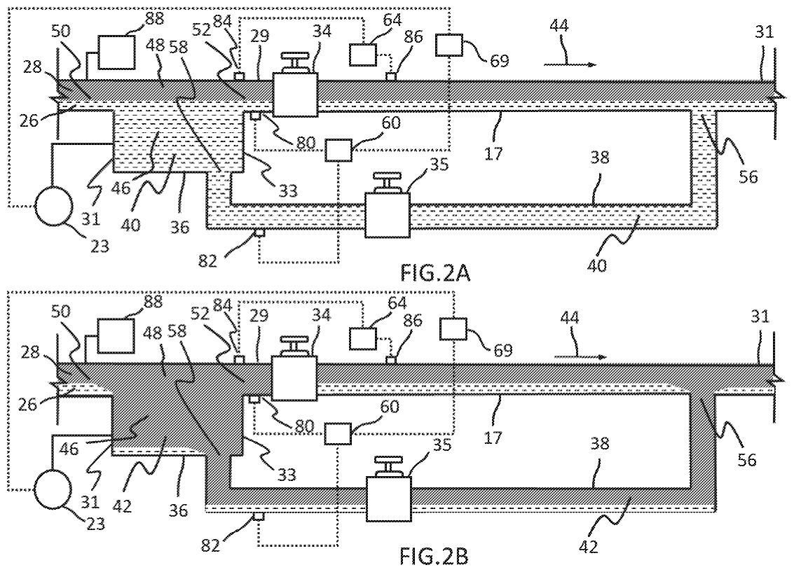

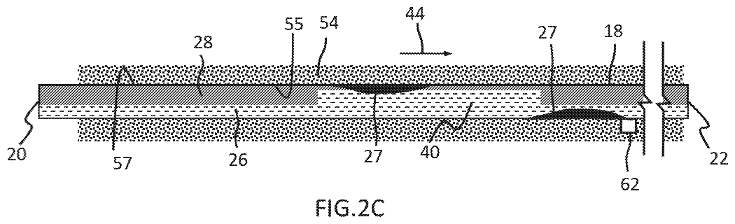

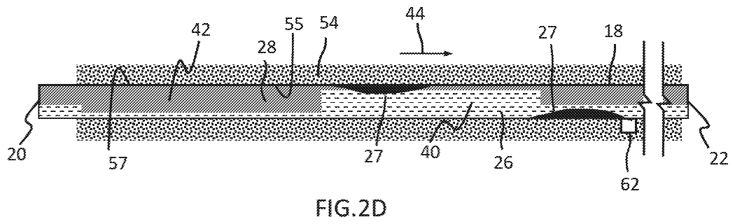

In Operation, referring to FIGS. 1, 2A, 2B, 2C, and 2D, according to a first embodiment, the following steps are performed: First, providing a flow (FIG. 1) of at least the liquid-containing fluid (not shown in FIG. 1) and the light fluid (not shown in FIG. 1) from first source 24, or from first source 24 and from second source 88, if provided, into first pipe-shaped or vessel-shaped body 36 through first body main inlet 50 and the first-body auxiliary inlet (not shown), if provided and used.

Next, substantially separating liquid-containing fluid generally indicated 26 (FIG. 2A) and light fluid generally indicated 28 from one another in first pipe-shaped or vessel-shaped body 36 and accumulating a volume generally indicated 40 of liquid-containing fluid 26, desired by the operator, in first-body lower part generally indicated 46 and/or second conduit 38, for example, by keeping first valve 34 and second valve 35, if provided, sufficiently open.

Next, substantially separating liquid-containing fluid 26 (FIG. 2B) and light fluid 28 from one another in first pipe-shaped or vessel-shaped body 36, accumulating a volume generally indicated 42 of light fluid generally indicated 28, and thereby substantially discharging volume 40 of liquid-containing fluid 26 through third-conduit opening 56 and third-conduit outlet end 90 into first-conduit 18 (FIG. 1), for example, by keeping valve 34 sufficiently closed; providing a flow of one or more transported substances 30 (FIG. 1) from first source 24 into first pipe-shaped or vessel-shaped body 36 to allow volume 40 of liquid-containing fluid 26 (FIG. 2C) to travel along first conduit 18 in direction 44, such that static or slowly moving substance 27 is accelerated in direction 44. Heat is transferred from volume 40 of liquid-containing fluid 26 having a first fluid temperature to inner wall 55 to increase the first temperature, if the first fluid temperature is greater than the first temperature; and/or heat is transferred from volume 40 of liquid-containing fluid 26 to outer wall 57 through inner wall 55 to increase the second temperature, if the first fluid temperature is greater than the second temperature. Heat is transferred from volume 40 of liquid-containing fluid 26 through inner wall 55 to water-containing solid medium 54 to decrease the moisture content, if the first fluid temperature is greater than the third temperature; and/or a desired concentration of the added substance (not shown) in liquid-containing fluid 26 or in light fluid 28 or in the one or more transported substances (not shown), or a desired velocity of the added substance, or a desired area of inner wall 55 being in contact with the added substance, or any combination thereof inside first conduit 18 is provided.

Also, step (d) may comprise performing step (a).

Furthermore, step (c) may comprise substantially discharging volume of light fluid 42 (FIG. 2B) into first conduit 18 from second conduit 38 and/or from first-body lower part 46 through third conduit 17, for example, by keeping first valve 34 sufficiently open.

Additionally, step (d) may comprise allowing volume of light fluid 42 (FIG. 2D) to travel along first conduit 18 in direction 44, such that static or slowly moving substance 27 is accelerated in direction 44; heat is transferred from volume of light fluid 42 having a second fluid temperature to inner wall 55 to increase the first temperature, if the second fluid temperature is greater than the first temperature; and/or heat is transferred from volume of light fluid 42 to outer wall 57 through inner wall 55 to increase the second temperature, if the second fluid temperature is greater than the second temperature; and/or heat is transferred from volume 42 of light fluid 28 through inner wall 55 to water-containing solid medium 54 to decrease the moisture content, if the second fluid temperature is greater than the third temperature; and/or the desired concentration of the added substance, or the desired velocity of the added substance, or the desired area of inner wall 55 being in contact with the added substance, or any combination thereof inside first conduit 18 is provided.

Also, step (d) may comprise performing repeatedly steps (a) and (c) to cause a plurality of volumes comprising the volume of the liquid-containing fluid and a plurality of volumes comprising the volume of light fluid to travel along the first conduit in the direction of movement of the one or more transported substances along the first conduit.

Similarly, at least steps (b) and/or (c) may comprise heating liquid-containing fluid 26 and/or light fluid 28 by the heating device (not shown in FIGS. 2A and 2B).

Also, if light fluid 28 (FIG. 2A) comprises the compressible fluid (not shown) and second valve 35 is provided, step (b) and/or step (c) may comprise accumulating light fluid 28 in first-body upper part 48 or in any other element located upstream first valve 34, for example, by keeping first valve 34 and second valve 35 sufficiently closed, until the second pressure difference is equal or greater than a known or determinable pressure difference. The known or determinable pressure difference provides a desired velocity of volume 40 of liquid-containing fluid 26 of FIG. 2C or of FIG. 2D.

Moreover, step (b) and/or step (c) may comprise measuring the first pressure difference by one or a plurality of devices 64 (FIGS. 2A and 2B) and determining a volume of liquid-containing fluid 26 or of light fluid 28 in first-body lower part 46 and/or in second conduit 38.

Furthermore, one or more controllers 69 (FIG. 2A) may measure a first time interval taken for the first pressure difference to increase from the specified first pressure difference to the specified second pressure difference and to calculate, for example, by the microprocessor, the difference between the first time interval and the set-point time. One or more controllers 69 regulates the flow rate of the added substance introduced into first pipe-shaped or vessel-shaped body 36 or into any other element of the system from third source 23, dependent upon the calculated difference to maintain the desired concentration of added substance in liquid-containing fluid 26 or light fluid 28 (FIG. 2B) or the one or more transported substances (not shown in FIG. 2A).

Also, second device 62 (FIG. 1) may measure the first temperature, or the second temperature, or the third temperature, or the moisture content, or any combination thereof at the desired location in first conduit 18 (FIG. 1) and one or more controllers 69 (FIG. 1A) communicating with second device 62 may calculate a first difference between the known or determinable critical moisture content and the measured moisture content, or a second difference between the known or determinable first sterilization temperature and the measured first temperature, or a third difference between the known or determinable second sterilization temperature, or any combination thereof; and regulate the amount of heat supplied to the liquid-containing fluid and/or to the light fluid in the heating device (not shown), dependent upon the first difference, or the second difference, or the third difference, or upon any combination thereof.

Also, if light fluid 28 (FIG. 2A) comprises the compressible fluid (not shown) and second valve 35 is provided, step (b) and/or step (c) may comprise measuring the second pressure difference by one or a plurality of devices 64 (FIGS. 2A and 2B) and determining a difference between the known or determinable pressure difference to partially or completely open first valve 34 and second valve 35, when the determined difference is greater than a specified difference.

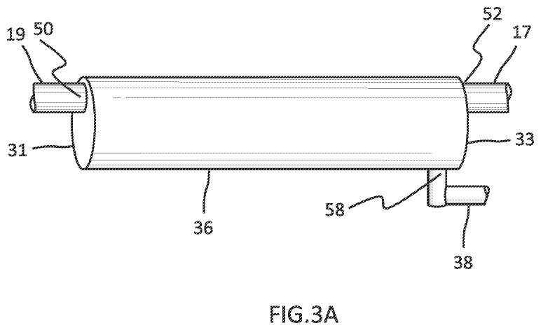

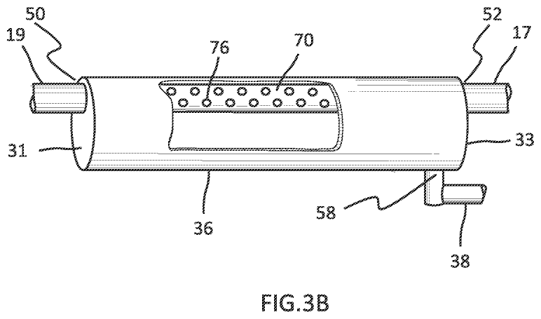

Referring to FIGS. 3A,3B, 4, 5, 6, 7A, 7B, 7C, 8A, 8B, and 9, additional embodiments are disclosed. In an additional embodiment, as shown in FIG. 3A, a first-body inlet pipe 19 may be connected to first body main inlet 50; first pipe-shaped or vessel-shaped body 36, second conduit 38, third conduit 17, and first-body inlet pipe 19 optionally have circular cross-sections; and a cross-sectional area of first pipe-shaped or vessel-shaped body 36 optionally is greater than the cross-sectional area of first conduit 18 (not shown in FIG. 3A).

In another additional embodiment, as shown in FIG. 3B, pipe-shaped or vessel-shaped body 36 of FIG. 3A may comprise a first body inserted pipe 70 disposed in an interior of pipe-shaped or vessel-shaped body 36 to connect first-body main inlet 50 with first-body upper outlet 52. First body inserted pipe 70 has a plurality of openings 76 (e.g., perforations or slots); and diameters of first conduit 18 (not show in FIG. 3B), first-body inlet pipe 19, third conduit 17, and of first-body inserted pipe 70 are equal or approximately equal, such that a measurement device (e.g., a “smart pig”, not shown) or a mechanical cleaning device (e.g., a “pig”, not shown) can be displaced through first-body inlet pipe 19, first pipe-shaped or vessel-shaped body 36, third conduit 17, and first conduit 18.

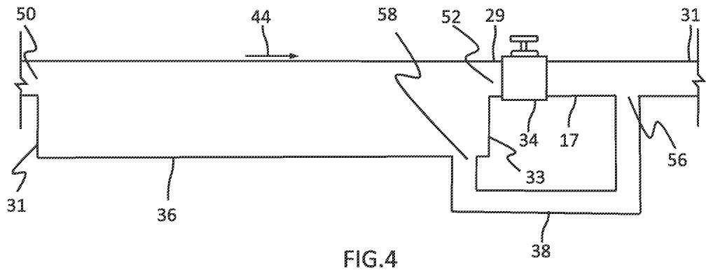

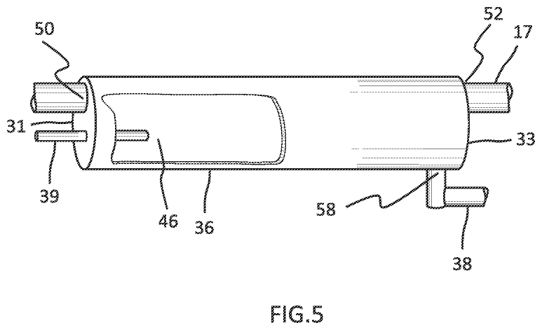

In another additional embodiment, as shown in FIG. 4, the internal volume of first pipe shaped or vessel-shaped body 36 can be greater than the internal volume of second conduit 38.

In another additional embodiment, as shown in FIG. 5, third source 23 (not shown in FIG. 5) of FIG. 1 may be in fluid communication with an injection pipe 39 inserted into or connected to pipe shaped or vessel-shaped body 36 to inject or introduce the added substance, preferably into first body lower part 46.

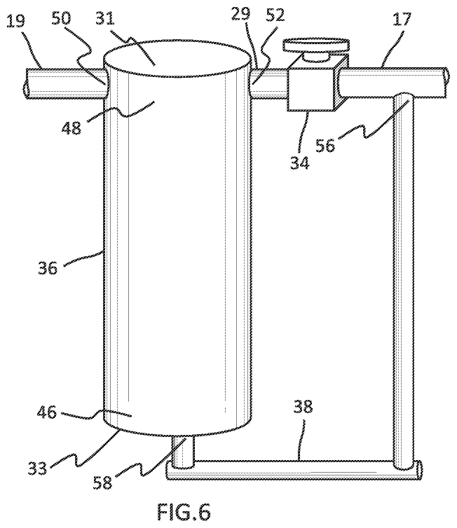

In another additional embodiment, as shown in FIG. 6, first pipe-shaped or vessel-shaped body 36 may be vertically oriented, such that first-body inlet end 31 is disposed in first-body upper part 48, and first-body outlet end 33 is disposed in first-body lower part 46, and first-body upper outlet 52 is disposed close to or at first-body inlet end 31.

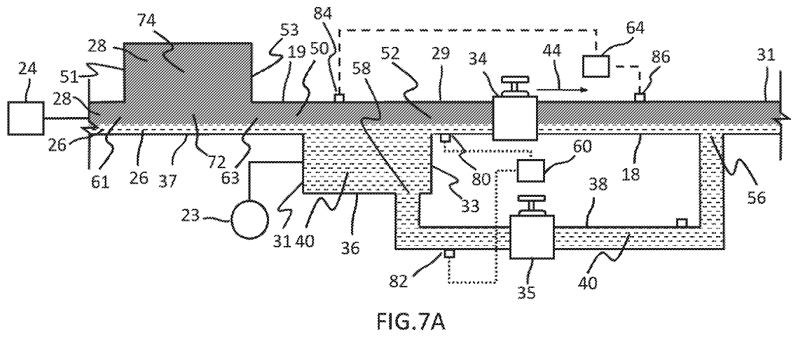

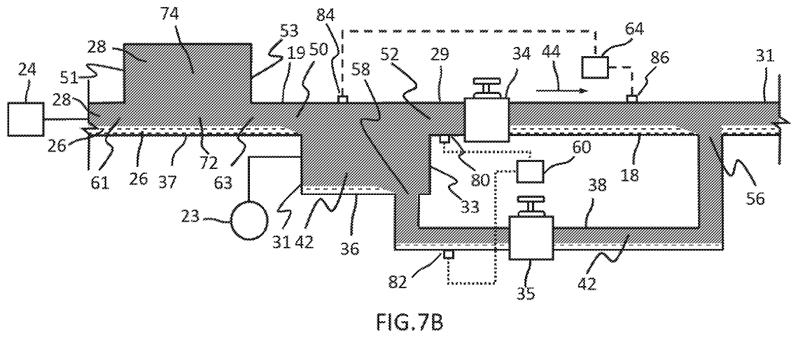

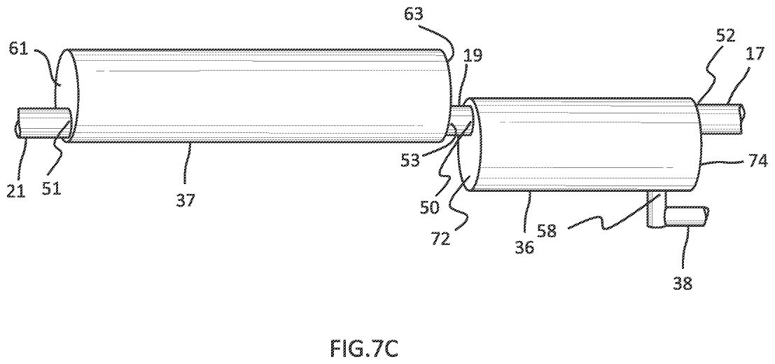

Another additional embodiment, as shown in FIG. 7A, is similar to the first embodiment of FIG. 1A except that there is a second pipe-shaped or vessel-shaped body 37, the light fluid 28 mandatorily comprises the compressible fluid, and second valve 35 is mandatorily provided. Functions of pipe-shaped or vessel-shaped body 37 comprise substantially separating liquid containing fluid 26 and light 28 fluid from one another, accumulating, and substantially discharging into first-body pipe-shaped or vessel-shaped body 36 a known or determinable amount of the compressible fluid required to provide the desired velocity of volume 40 of liquid-containing fluid 26 of FIG. 2C or of FIG. 2D over a desirable time interval. Second pipe-shaped or vessel-shaped body 37 is disposed at a suitable location upstream of first valve 34, for example, upstream of pipe-shaped or vessel-shaped body 36, as shown in FIG. 7A. Second pipe-shaped or vessel-shaped body 37 has a second-body lower part generally indicated 72, a second-body upper part generally indicated 74, a second-body inlet end 51, a second-body outlet end 53, a second-body inlet 61, and a second-body outlet 63. Second-body inlet 61 is disposed close to or at second-body inlet end 51, preferably in second-body lower part 72. Second-body outlet 63 is disposed close to or at second body outlet end 53 in second-body lower part 72. First-body main inlet 50 is connected to second-body outlet 63, preferably by first-body inlet pipe 19. First source 24 may be connected fluidly to second-body inlet 61. The operation of the embodiment of FIGS. 7A and 7B is similar to that of the first embodiment of FIGS. 2A and 2B, except that the known or determinable amount of the compressible fluid is accumulated in second pipe-shaped or vessel-shaped body 37 in step (b) and/or step (c), and then is subsequently discharged into first-body pipe-shaped or vessel-shaped body 36 in step (c) or in step (c) and step (d).

Also, as shown in FIG. 7C, the additional embodiment of FIG. 7A may comprise a second-body inlet pipe 21 connected to second-body inlet 51; second pipe-shaped or vessel-shaped body 37, second-body inlet pipe 21, and first-body inlet pipe 19 having circular cross-sections; and a cross sectional area of second pipe-shaped or vessel-shaped body 37 is greater than the cross-sectional area of first conduit 18.

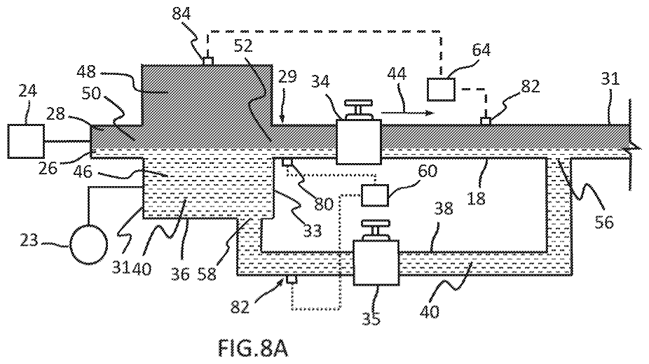

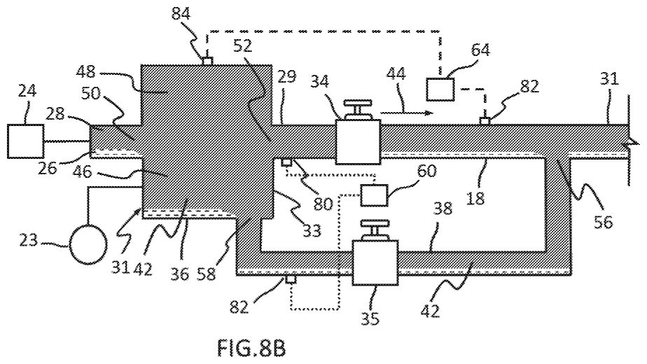

In yet another additional embodiment, as shown in FIG. 8A, the light fluid 28 mandatorily comprises the compressible fluid, second valve 35 is provided, and first-body upper outlet end 52 is disposed between first-body lower part 46 and first-body upper part 48. Also, first-body main inlet 50 may disposed between first-body lower part 46 and first body upper part 48. The operation the embodiment of FIG. 8A and 8B is similar to that of another embodiment of FIGS. 7A and 7B, except that the known or determinable amount of the compressible fluid is accumulated in first-body upper part 48 in step step (b) and/or step (c) and is expanded into first-body lower part 46 in step (c) or in step (c) and step (d).

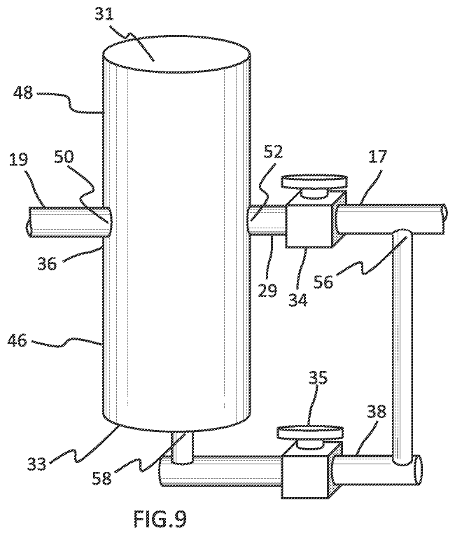

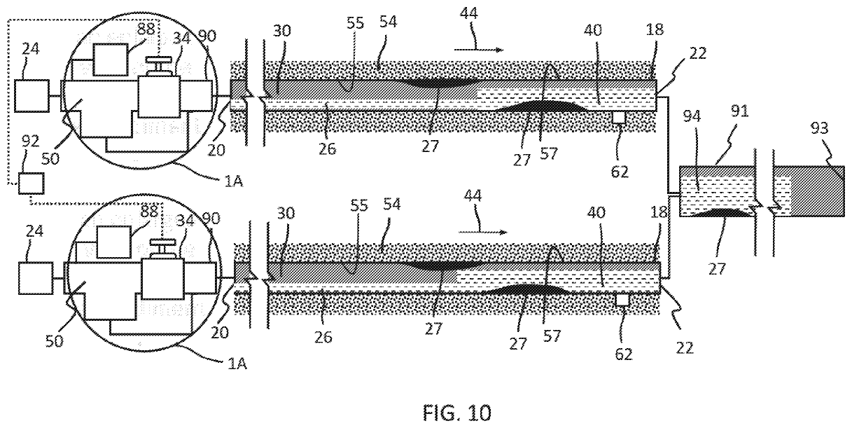

In another additional embodiment, as shown in FIG. 9, first pipe-shaped or vessel-shaped body 36 of FIG. 8A may be vertically oriented, such that first-body inlet end 31 is disposed in first body upper part 48, and first-body outlet end 33 is disposed in first-body lower part 46, and first body upper outlet 52 is disposed between first-body lower part 46 and first-body upper part 48.

Referring to FIG. 16, yet another embodiment comprises a plurality of systems of FIG. 1, a second controller 92 controlling the first valve 34, and a common conduit 91 (e.g., a gathering oil or gas pipeline, a manifold, a header, or a process line within a processing facility) having a common-conduit outlet end 93. First-conduit outlet end 22 of each first conduit 18 communicates fluidly with common conduit 91. The operation of the embodiment of FIG. 16 is similar to that of the first embodiment of FIGS. 2A and 2B, except that second controller 92 of FIG. 16 opens and closes each first valve 34 such that a volume 40 of liquid-containing fluid 26 from one of the plurality of systems enters the common conduit 91 substantially simultaneously with the volume 40 of liquid-containing fluid 26 from at least another of the plurality of systems to form a volume 94 of liquid-containing fluid 26 moving toward the common-conduit outlet end 93.

Advantages

From the description, above, a number of advantages of some embodiments of the method and system become evident:

The static or slowly moving substance can be accelerated in the direction toward the first conduit outlet end of the first conduit without increasing a flow rate of one or more transported substances at the first source.

The static or slowly moving substance can be accelerated in the direction toward the first conduit outlet end to a specified velocity, when the light fluid is a compressible fluid, without increasing the flow rate of one or more transported substances at the first source.

The method and system can be used in applications where the flow rate of one or more transported substances at the first source is constant (e.g., in a flowline connected to an oil or gas well operated at a critical flow rate condition at the wellhead).

A pressure drop between first-conduit inlet end and first-conduit outlet end can be decreased without increasing the flow rate of one or more transported substances at the first source.

The first temperature may be raised without increasing the flow rate of one or more transported substances at the first source and/or without heating one or more transported substances.

The second temperature may be raised without increasing the flow rate of one or more transported substances at the first source and/or without heating one or more transported substances.

The moisture content in the water-containing solid medium being in contact with the outer wall of the first conduit may be decreased without increasing the flow rate of one or more transported substances at the first source and/or without heating the one or more transported substances.

The desired concentration of the added substance, or the desired velocity of the added substance, or the desired area of the inner wall being in contact with the added substance, or any combination thereof in the first conduit may be provided without increasing the flow rate of one or more transported substances at the first source.

The desired concentration of the added substance in the liquid containing fluid can be automatically provided when the flow rate of one or more transported substances at the first source vary in time.

The desired concentration of the added substance in the liquid-containing fluid can be provided without measuring a flow rate of the liquid-containing fluid and/or a flow rate of one or more transported substances using an additional measuring means.

The added substance can be injected directly into liquid-containing fluid for most of the time, thereby reducing the injection rate of the added substance required to provide the desired concentration of the added substance in the liquid-containing fluid (e.g., in water).

The “smart pig” or any other “pig” can be displaced through some embodiments of the system and the first conduit.

In some embodiments, the static or slowly moving substance can be removed from first conduit without the need for running a “pig”.

The method and system can be used in applications where the first conduit has an arbitrary length, by using one or a plurality of embodiments described herein and disposed or connected to the first conduit at a plurality suitable locations along the first conduit.

Circular pipes or cylindrical vessels can be used to construct the first pipe-shaped or vessel shaped body and the second pipe-shaped or vessel-shaped body to reduce the cost of the system.

The method and system may be used in applications where there are space limitations or where the first pipe-shaped or vessel-shaped body and the second pipe-shaped or vessel shaped body, if provided, are buried, by selecting the design and orientation of the first pipe shaped or vessel-shaped body and the second pipe-shaped or vessel-shaped body, if provided.

In some embodiments, internal and external corrosion caused microorganisms can be prevented automatically in applications where the flow rate of one or more transported substances, or of the liquid-containing fluid, or of the light fluid at the first source vary in time.

In some embodiments, external corrosion caused by a high moisture content in water containing solid medium surrounding first conduit can be automatically prevented, when the moisture content changes with time (e.g., because of seasonal variations of soil temperature and/or moisture content).

A sufficiently large first volume of the liquid-containing fluid within a common conduit can be formed by merging two or more first volumes of the liquid-containing fluid flowing from a plurality of the systems connected to the common conduit.

Ramifications and Scope

The method and system has been described in an illustrative manner, and it is to be understood that the terminology which has been used is intended to be in the nature of words of description rather than of limitation. Obviously, many modifications and variations of the present method and system are possible in light of the above teachings. For example, a capacitance probe not shown in the drawings can be provided to measure a volume of the liquid-containing fluid or of the light fluid in first-body lower part 46 and/or in second conduit 38. Also, a heating device using solar energy, not shown in the drawings, may be provided for heating up the liquid-containing fluid and/or of the light fluid. It is, therefore, to be understood that within the scope of the appended claims, the method and system may be practiced otherwise than as specifically described.

What is claimed is:

1. A conduit system for transporting solids and/or fluids, comprising:
a first pipe-shaped or vessel-shaped body, comprising:
a first-body lower part;
a first-body upper part disposed above the first-body lower part;
a first-body inlet end;
a first-body outlet end;
a first-body main inlet;
a first-body upper outlet; and
a first-body lower outlet;
a second conduit in fluid communication with the first-body lower outlet;
a third conduit, comprising:
a third-conduit inlet end;
a third-conduit outlet end in fluid communication with the first pipe-shaped or vessel-shaped body; and
a third-conduit opening in fluid communication with the second conduit;
a first valve disposed in the third conduit between third-conduit inlet end and the third-conduit opening;
wherein the first-body upper outlet is connected to the third-conduit inlet end or to the first valve.

2. The system of claim 1, further comprising:
a first port disposed in the third conduit or in the first body upper part;
a second port disposed in the second conduit or in the first-body lower part; and
a first device for measuring a first pressure difference between the first port and the second port to determine a volume of the liquid-containing fluid or of the light fluid in first-body lower part and/or in second conduit.

3. The system of claim 1, further comprising:
a second device for measuring temperature and/or moisture content at a desired location in the first pipe-shaped or vessel-shaped body.

4. The system of claim 1, further comprising a heating device disposed upstream of third-conduit opening, for heating up the liquid-containing fluid and/or the light fluid.

5. The system of claim 4, further comprising: a controller, having a processor and a memory, configured to regulate the amount of heat supplied to the liquid-containing fluid and/or to the light fluid in the heating device;
wherein the controller is in communication with the heating device and has, stored on the memory, a known or determinable critical moisture content or a known or determinable first sterilization temperature or a known or determinable second sterilization temperature or any combination thereof.

6. The system of claim 5, wherein the controller is configured to regulate a flow rate of an added substance introduced into the first pipe-shaped or vessel-shaped body or into any other element of the system from a source;
wherein the controller comprises a timer for measuring a time interval and is configured to store a set-point time, a first specified pressure difference, and a second specified pressure difference greater than the first specified pressure difference.

7. The system of claim 1 , further comprising a second valve for changing a flow rate of fluids through the first-body lower outlet, disposed in the second conduit.

8. The system of claim 1, further comprising:
a first-body inlet pipe connected to the first-body main inlet;
wherein the first pipe-shaped or vessel-shaped body, the second conduit, the third conduit, and the first-body inlet pipe have circular cross-sections; and
a cross-sectional area of the first pipe-shaped or vessel-shaped body is greater than the cross-sectional area of the first pipe-shaped or vessel-shaped body.

9. A plurality of the systems of claim 1, further comprising:
a controller controlling the first valves;
a common conduit having an a common-conduit outlet end;
wherein the first-body outlet ends of each first pipe-shaped or vessel-shaped body communicates fluidly with the common conduit;
wherein the controller is configured to open and close the first valve such that a volume of liquid-containing fluid enters the common conduit substantially simultaneously with volumes of liquid-containing fluid from at least another of the plurality of systems to form a volume of liquid-containing fluid moving toward the common-conduit outlet end.

10. The system of claim 1, wherein an internal volume of the first pipe-shaped or vessel-shaped body is greater than an internal volume of second conduit.

11. The system of claim 1, wherein a source is in fluid communication with an injection pipe inserted into or connected to the first pipe-shaped or vessel-shaped body to inject or introduce an added substance into the first body lower part.

12. The system of claim 1, wherein the first pipe-shaped or vessel-shaped body is vertically oriented, such that first body inlet end is disposed in the first-body upper part, and the first-body outlet end is disposed in the first-body lower part, and the first-body upper outlet is disposed adjacent to or at first-body inlet end.

13. The system of claim 1, further comprising:
a second valve; and
a second conduit, for separating the liquid containing fluid from the light fluid, accumulating, and substantially discharging the fluids into the first pipe-shaped or vessel-shaped body a known or determinable amount of compressible fluid required to provide a desired velocity of volume of liquid-containing fluid over a desirable time interval.

14. The system of claim 1, wherein the second conduit comprises:
a second-body lower part;
a second-body inlet end;
a second-body inlet disposed close to or at second-body inlet end in the second-body lower part;
a second-body upper part;
a second-body outlet end; and
a second-body outlet disposed close to or at second body outlet end in the second-body lower part;
wherein the first-body main inlet is connected to the second body outlet by a first-body inlet pipe.

15. The system of claim 14, wherein the second conduit further comprises a second-body inlet pipe connected to the second-body inlet.

16. The system of claim 14, further comprising:
a second valve;
wherein the first-body upper outlet end is disposed between first-body lower part and first-body upper part;
wherein the first-body main inlet is disposed between the first-body lower part and the first-body upper part;
wherein the system is configured to accumulate a known or determinable amount of compressible fluid in the first-body upper part and then expanded into the first-body lower part.

17. The system of claim 16, wherein the first pipe-shaped or vessel-shaped body is vertically oriented, such that the first-body inlet end is disposed in the first body upper part, and the first-body outlet end is disposed in first body lower part, and the first body upper outlet is disposed between first-body lower part and first-body upper part.

18. A method of fluid transport in a pipe system, comprising:
providing a flow of liquid-containing fluid and light fluid into a first pipe-shaped or vessel-shaped body;
substantially separating the liquid-containing fluid from the light fluid in the first pipe-shaped or vessel-shaped body and accumulating a first volume of liquid-containing fluid in a first body lower part and/or a second conduit;
substantially separating the liquid-containing fluid from the light fluid in the first pipe-shaped or vessel-shaped body and accumulating a second volume of light fluid; and
substantially discharging the first volume of liquid-containing fluid through a third-conduit opening and a third-conduit outlet end into a first conduit.

19. A method of fluid transport in a pipe system, having an inner wall and an outer wall, comprising:
providing a flow of one or more transported substances into a first pipe-shaped or vessel-shaped body to allow a first volume of liquid-containing fluid to travel along a first conduit in a direction, such that a static or slowly moving substance is accelerated in the direction;
transferring heat from the first volume of liquid-containing fluid to the inner wall to increase its temperature, if a temperature of the fluid is greater than the temperature of the inner wall;
transferring heat from the first volume of liquid-containing fluid to the outer wall through the inner wall to increase a temperature of the outer wall; and
transferring heat from the first volume of liquid-containing fluid through the inner wall to a water-containing solid medium to decrease its moisture content.

20. The method of claim 19, wherein a substance is added to the liquid-containing fluid or in light fluid or to the one or more transported substances.
